(19) United States
(12) Patent Application Publication
(10) Pub. No.: US 2020/0349689 A1
(43) Pub. Date: Nov. 5, 2020

(54) IMAGE PROCESSING METHOD AND DEVICE, UNMANNED AERIAL VEHICLE, SYSTEM AND STORAGE MEDIUM

(71) Applicant: SZ DJI TECHNOLOGY CO., LTD., Shenzhen (CN)

(72) Inventors: Chao WENG, Shenzhen (CN); Zhenguo LU, Shenzhen (CN); Lei YAN, Shenzhen (CN)

(21) Appl. No.: 16/932,570

(22) Filed: Jul. 17, 2020

Related U.S. Application Data
(63) Continuation of application No. PCT/CN2018/107480, filed on Sep. 26, 2018.

(51) Int. Cl. G06T 5/50; G06T 9/00; H04N 5/225; H04N 5/247; G06T 7/80

(52) U.S. Cl. CPC G06T 5/50; G06T 9/00; H04N 5/2253; G06T 2207/20221; G06T 7/80; G06T 2207/10048; G06T 2207/30252; H04N 5/247

(57) ABSTRACT

An image processing method includes obtaining a first band image and a second band image, performing transparency processing on the first band image to obtain an intermediate image, and superimposing the intermediate image and the second band image to obtain a target image. The present disclosure also provide an image processing device and an unmanned aerial vehicle using the method above.

### CROSS-REFERENCE TO RELATED APPLICATION

This application is a continuation of International Application No. PCT/CN2018/107480, filed on Sep. 26, 2018, the entire content of which is incorporated herein by reference.

### TECHNICAL FIELD

The present disclosure relates to the technical field of unmanned aerial vehicle technology and, more particularly, to an image processing method and device, an unmanned aerial vehicle, a system, and a storage medium.

### BACKGROUND

As aviation technologies advance, unmanned aerial vehicles have become a popular research subject and are widely used in vegetation protection, aerial shooting, forest fire monitoring, etc., bringing in substantial benefits to people's daily life and work environment.

In aerial photography applications, a camera is often used for photographing. In practice, it is found that information captured in such photographs is limited. For example, when an infrared camera is used for photographing, an infrared lens of the infrared camera captures infrared radiation information of a photographed object through infrared radiation detection. The infrared radiation information faithfully reflects temperature information of the photographed object. However, the infrared lens is insensitive to brightness change of a photographed scene, resulting in undesired image resolution. The photographed image is unable to reflect detailed feature information of the photographed object. In another example, a visible light camera lens is used for photographing. The visible light camera lens can capture a substantially clear image that reflects the detailed feature information of the photographed object. However, the visible light camera lens is unable to capture the infrared radiation information of the photographed object. The photographed image is unable to reflect the temperature information of the photographed object. Thus, how to capture high quality images becomes a popular research subject.

### SUMMARY

In accordance with the disclosure, there is provided an image processing method including obtaining a first band image and a second band image, performing transparency processing on the first band image to obtain an intermediate image, and superimposing the intermediate image and the second band image to obtain a target image.

Also in accordance with the disclosure, there is provided an image processing device including a memory storing program instructions and a processor configured to execute the program instructions to obtain a first band image and a second band image, perform transparency processing on the first band image to obtain an intermediate image, and superimpose the intermediate image and the second band image to obtain a target image.

Also in accordance with the disclosure, there is provided an unmanned aerial vehicle (UAV) including a body, a power system arranged at the body and configured to provide flying power, a photographing apparatus mounted at the body, and a processor configured to obtain a first band image and a second band image, perform transparency processing on the first band image to obtain an intermediate image, and superimpose the intermediate image and the second band image to obtain a target image.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an unmanned aerial vehicle (UAV) system according to an example embodiment of the present disclosure.

FIG. 2 is a flowchart of a method for image processing according to an example embodiment of the present disclosure.

FIG. 3 is a flowchart of a method for image processing according to another example embodiment of the present disclosure.

FIG. 4 is a flowchart of a method for aligning a first preview image and a second preview image according to an example embodiment of the present disclosure.

FIG. 5 is a flowchart of a method for aligning a relative position between an infrared photographing device and a visible light photographing device according to an example embodiment of the present disclosure.

FIG. 6 is a schematic structural diagram of an image processing device according to an example embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

Embodiments of the present disclosure are described in detail below with reference to the accompanying drawings. In the case of no conflict, the following embodiments and features of the embodiments can be combined with each other.

To solve the problem of compromised quality of the imaged photographed with the existing technology, the present disclosure provides a method for image processing. The method includes: using a photographing apparatus to obtain a first band image and a second band image or receiving the first band image and the second band image sent from another device, performing a transparency processing on the first band image to obtain a first intermediate image, and combining the first intermediate image and the second band image to obtain a target image.

The target image includes information of the first band image and information of the second band image. More information can be obtained from the target image and the quality of the photographed image can be improved. For example, the first band image is an infrared image and the second band image is a visible light image. The first band image includes temperature information of a photographed object. The second band image includes detailed feature information of the photographed object. The target image obtained based on the first band image and the second band image not only includes the temperature information of the photographed object, but also includes the detailed feature information of the photographed object.

In addition, through performing the transparency processing on the first band image, the target image can mainly highlight the information of the second band image and use the information of the first band image as auxiliary information, such that a user may obtain the target image focusing on different feature information according to actual needs.

The embodiments of the present disclosure may be applied to various fields, such as military defense, remote sensing detection, environment protection, traffic monitoring, or disaster surveillance, etc. In these fields, an unmanned aerial vehicle (UAV) is often used to photograph environment images from above and the environment images are analyzed and processed to obtain pertaining information. For example, in the field of environment protection, the UAV is used to photograph the environment images of an area, which may be where a river is located. The environment images of the area are analyzed to obtain data about water quality of the river. The data about the water quality of the river may be used to determine whether the river is polluted.

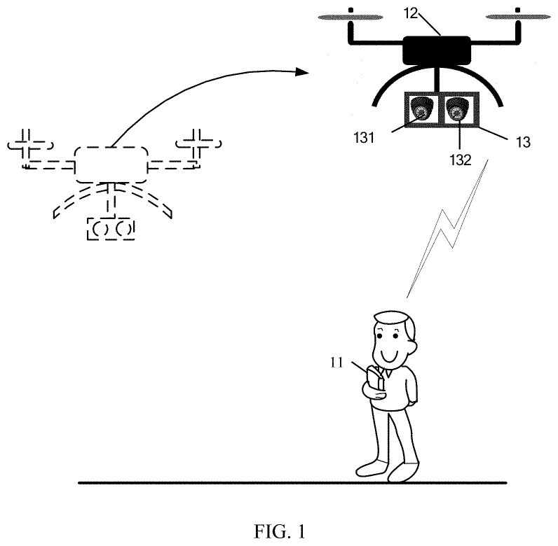

For convenience of illustration, before describing the method for image processing of the present disclosure, a UAV system used in various embodiments of the present disclosure is described. FIG. 1 is a schematic structural diagram of an unmanned aerial vehicle (UAV) system according to an example embodiment of the present disclosure. As shown in FIG. 1, the system includes: a smart terminal 11, a UAV 12, and a photographing apparatus 13.

The smart terminal 11 can be a control terminal of the UAV, such as one or more of a remote controller, a smart phone, a tablet computer, a laptop computer, a ground terminal, a wearable device (e.g., a watch or a wrist band). The UAV 12 can be a rotor-type UAV, such as a 4-rotor UAV, a 6-rotor UAV, or an 8-rotor UAV, or can be a fixed wing UAV. The UAV 12 includes a power system. The power system provides flying power to the UAV 12. The power system includes one or more of a propeller, an electric motor, and an electric speed controller (ESC). The UAV 12 also includes a gimbal. The photographing apparatus 13 is mounted at a main body of the UAV 12 through the gimbal.

The photographing apparatus 13 at least includes an infrared photographing device 131 and a visible light photographing device 132. The infrared photographing device 131 and the visible light photographing device 132 have different photographing advantages. For example, the infrared photographing device 131 captures infrared radiation information of the photographed object. Images photographed by the infrared photographing device 131 can better reflect the temperature information of the photographed object. The visible light photographing device 132 captures images with a relatively high resolution. The images photographed by the visible light photographing device 132 can reflect detailed feature information of the photographed object. The gimbal is a multi-axis stabilization system. Gimbal electric motors adjust rotation angles of the axes to compensate for a photographing attitude of the photographing apparatus 13. The gimbal also prevents or reduces vibration of the photographing apparatus 13 through a suitable buffering mechanism.

In some embodiments, the smart terminal 11 is an interaction device facilitating human-machine interaction. The interaction device can be one or more of a touch display screen, a keyboard, a button, a joystick, and a click wheel. The interaction device provides a user interface. During the flight of the UAV 12, the user may configure a photographing position through the user interface. For example, the user may enter information of the photographing position through the user interface. The user may perform a touch-control operation (e.g., a clicking operation or a sliding operation) on a flight path of the UAV 12. Accordingly, the smart terminal 11 may determine the photographing position based on the touch-control operation.

After receiving the photographing position, the smart terminal 11 sends position information corresponding to the photographing position to the photographing apparatus 13. When the UAV 12 flies over the photographing position and the photographing apparatus 13 detects that the infrared photographing device 131 and the visible light photographing device 132 are aligned, the infrared photographing device 131 is controlled to photograph the first band image and the visible light photographing device 132 is controlled to photograph the second band image. The transparency processing is performed on the first band image to obtain the first intermediate image. The first intermediate image and the second band image are superimposed to obtain the target image. The target image includes the information of the first band image and the information of the second band image. Substantially more information can be obtained from the target image to improve information diversity of the photographed image.

In some embodiments, after the smart terminal 11 receives the photographing position, the position information corresponding to the photographing position is sent to the photographing apparatus 13. When the UAV 12 flies over the photographing position, the photographing apparatus 13 controls the infrared photographing device 131 to photograph the first band image and controls the visible light photographing device 132 to photograph the second band image. The first band image and the second band image are sent to the smart terminal 11. The smart terminal 11 performs the transparency processing on the first band image to obtain the first intermediate image. The first intermedia image and the second band image are superimposed to obtain the target image.

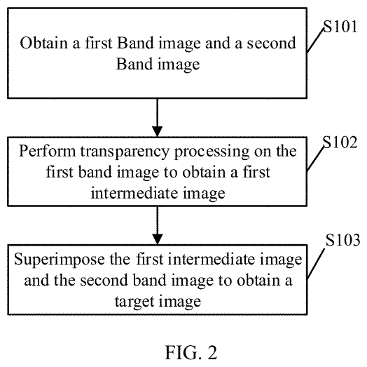

FIG. 2 is a flowchart of a method for image processing according to an example embodiment of the present disclosure. The method can be applied to the above-described photographing apparatus. The method includes obtaining a first band image and a second band image (at S101).

In some embodiments, the photographing apparatus photographs the first band image and the second band image or receives the first band image and the second band image sent from other devices. The first band image and the second band image are photographed by a photographing device capable of capturing signal at various wavelengths. For example, the photographing apparatus includes the infrared photographing device and the visible light photographing device. The infrared photographing device captures infrared signals at wavelengths ranging approximately between 10⁻³ m and 7.8×10⁻⁷ m. That is, the infrared photographing device photographs the first band image. The first band image is an infrared image. The visible light photographing device captures visible light signals at wavelengths ranging approximately between 7.8×10⁻⁵ cm and 3.8×10⁻⁶ cm. That is, the visible light photographing device photographs the second band image. The second band image is a visible light image.

A central horizontal distribution condition is satisfied between the infrared photographing device and the visible light photographing device of the photographing apparatus. Alternatively or in addition, relative position between the infrared photographing device and the visible light photographing device of the photographing apparatus is smaller than or equal to a tolerance threshold.

In some embodiments, to ensure that a field of view (FOV) of the infrared photographing device covers the field of view of the visible light photographing device and at the same time ensures that the FOV of the infrared photographing device and the FOV of the visible light photographing device do not interfere with each other, the photographing apparatus can align the infrared photographing device and the visible light photographing device with each other. For example, the photographing apparatus detects whether the central horizontal distribution condition is satisfied between the infrared photographing device and the visible light photographing device of the photographing apparatus and/or whether the relative position between the infrared photographing device and the visible light photographing device of the photographing apparatus is smaller than or equal to the tolerance threshold.

When it is detected that the central horizontal distribution condition is not satisfied between the infrared photographing device and the visible light photographing device of the photographing apparatus, and/or that the relative position between the infrared photographing device and the visible light photographing device of the photographing apparatus is greater than the tolerance threshold, the infrared photographing device and the visible light photographing device are not structurally aligned with each other and the photographing apparatus outputs alert information.

The alert information may include a manner for adjusting the infrared photographing device and/or the visible light photographing device, such that the infrared photographing device and the visible light photographing device can align with each other. For example, the alert information includes adjusting the infrared photographing device to the left by 5 mm. The alert information alerts a user to adjust the infrared photographing device and/or the visible light photographing device to align the infrared photographing device and the visible light photographing device with each other. In some embodiments, when the central horizontal distribution condition is not satisfied between the infrared photographing device and the visible light photographing device of the photographing apparatus and/or the relative position between the infrared photographing device and the visible light photographing device of the photographing apparatus is greater than the tolerance threshold, the photographing apparatus adjusts a position of the infrared photographing device and/or the position of the visible light photographing device to align the infrared photographing device and the visible light photographing device with each other.

When the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold, the infrared photographing device and the visible light photographing device are structurally aligned with each other. The photographing apparatus receives a photographing instruction sent from the smart terminal or receives the photographing instruction sent from the user to the photographing apparatus. The photographing instruction carries photographing position information. When the photographing apparatus reaches the photographing position (or the UAV to the photographing apparatus is mounted flies over the photographing position), the infrared photographing device is triggered to photograph the first band image and the visible light photographing device is triggered to photograph the second band image.

In some embodiments, the photographing apparatus includes a main board. The infrared photographing device is fixedly connected to the main board. The visible light photographing device is locked to the main board through a spring. When the infrared photographing device and the visible light photographing device are not structurally aligned, the photographing apparatus adjusts the position of the visible light photographing device, such that the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold.

In some embodiments, both the infrared photographing device and the visible light photographing device are locked to the main board through springs. When the infrared photographing device and the visible light photographing device are not structurally aligned, the photographing apparatus adjusts the position of the infrared photographing device and/or the position of the visible light photographing device, such that the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold.

Satisfying the central horizontal distribution condition between the infrared photographing device and the visible light photographing device refers to that a height difference between the infrared photographing device and the visible light photographing device is smaller than a pre-set height value. The pre-set height value is set according to user's needs for image photographing or according to structural properties of the infrared photographing device and the visible light photographing device.

At S102, a transparency processing is performed on the first band image to obtain a first intermediate image.

In some embodiments, to use information of the first band image as auxiliary information of a target image, the photographing apparatus performs the transparency processing on the first band image to obtain the first intermediate image. The first intermediate image includes a portion of the information of the first band image. An amount of the information of the first band image included in the first intermediate image is related to a transparency parameter of the transparency processing. The greater the transparency parameter is, the more amount of the information of the first band image is included in the first intermediate image. Conversely, the smaller the transparency parameter is, the less amount of the information of the first band image is included in the first intermediate image. The transparency parameter can be a fixed value or a variable value. For example, the transparency parameter can be dynamically adjusted according to application scenes or the user's needs.

At S103, the first intermediate image and the second band image are superimposed to obtain the target image.

In some embodiments, to obtain more information from the target image, the photographing apparatus superimposes the first intermediate image and the second band image to obtain the target image. In one example, the first intermediate image is superimposed on top of the second band image to obtain the target image. In another example, the second band image is superimposed on top of the first intermediate image. In another example, each of the first intermediate image and the second band image is divided into multiple layers. Various layers of the first intermediate image and corresponding layers of the second band image are superimposed alternately to obtain the target image.

In some embodiments, the transparency processing is performed on the first band image to obtain the first intermediate image. The first intermediate image and the second band image are superimposed to obtain the target image. The target image includes the information of the first band image and the information of the second band image. More amount of the information can be obtained from the target image to improve the quality of the photographed image. In addition, through performing the transparency processing on the first band image, the target image can highlight the information of the second band image and use the information of the first band image as auxiliary information, such that a target image including primary and secondary information can be obtained.

In addition, when it is detected that the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold, the infrared photographing device and the visible light photographing device are structurally aligned with each other and a software program for the alignment is not needed. The above-described alignment method is more reliable and results in more desired photographed images.

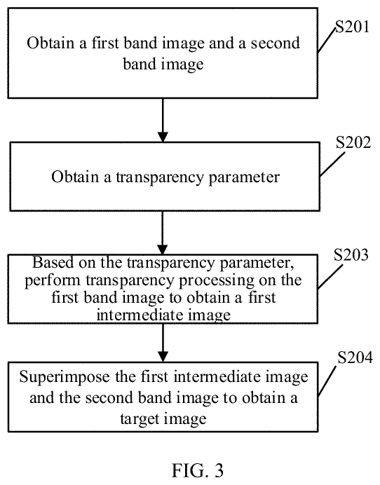

FIG. 3 is a flowchart of a method for image processing according to another example embodiment of the present disclosure. The method can be applied to the above-described photographing apparatus. As shown in FIG. 3, the method for image processing includes obtaining a first band image and a second band image (S201).

The first band image is an infrared image. The second band image is a visible light image. The infrared image is photographed by the infrared photographing device of the photographing apparatus. The visible light image is photographed by the visible light photographing device of the photographing apparatus. The central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold.

In some embodiments, the smart terminal sends the photographing instruction to the photographing apparatus, or the user sends the photographing instruction to the photographing apparatus through a voice command, or the user sends the photographing instruction to the photographing apparatus through performing a touch-control operation at a user interface of the photographing apparatus. The photographing instruction carries the information of the photographing position.

When the photographing apparatus receives the photographing instruction, detects that the infrared photographing device and the visible light photographing device of the photographing apparatus are aligned with each other, and reaches the photographing position (or the UAV mounted with the photographing apparatus flies over the photographing position), the infrared photographing device is triggered to photograph the first band image and the visible light photographing device is triggered to photograph the second band image. The infrared photographing device is an infrared camera and the visible light photographing device is a visible light camera. The first band image photographed by the infrared photographing device is the infrared image. The second band image photographed by the visible light photographing device is the visible light image.

Before S201, the method further includes performing alignment on the relative position between the infrared photographing device and the visible light photographing device based on the position information of the infrared photographing device and the position information of the visible light photographing device.

To ensure that the FOV of the infrared photographing device covers the FOV of the visible light photographing device and at the same time the FOV of the infrared photographing device and the FOV of the visible light photographing device do not interfere with each other, the photographing apparatus performs alignment on the relative position between the infrared photographing device and the visible light photographing device. For example, the photographing apparatus performs alignment on the relative position between the infrared photographing device and the visible light photographing device based on the position information of the infrared photographing device and the position information of the visible light photographing device.

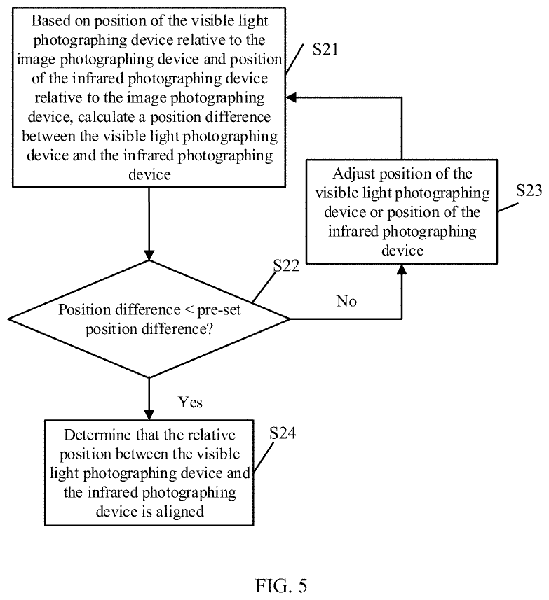

In some embodiments, performing alignment on the relative position between the infrared photographing device and the visible light photographing device based on the position information of the infrared photographing device and the position information of the visible light photographing device includes the following processes S21-S24 as shown in FIG. 5.

At S21, a position difference between the infrared photographing device and the visible light photographing device is calculated based on a lens position of the infrared photographing device relative to the photographing apparatus and a lens position of the visible light photographing device relative to the photographing apparatus.

At S22, whether the position difference is smaller than a pre-set position difference is determined. If the position difference is greater than or equal to the pre-set position difference, S23 is executed. Otherwise, S24 is executed.

At S23, it is triggered to adjust the position of the infrared photographing device or the position of the visible light photographing device.

At S24, it is determined that the infrared photographing device and the visible light photographing device are aligned with each other.

In the above-described processes S21-S24, the position difference between the infrared photographing device and the visible light photographing device is calculated based on the lens position of the infrared photographing device relative to the photographing apparatus and the lens position of the visible light photographing device relative to the photographing apparatus. The position difference includes a height position difference and/or a horizontal distance position difference. Determining whether the position difference is smaller than the pre-set position difference includes determining whether the height position difference is smaller than a pre-set height and/or determining whether the horizontal distance position difference is smaller than a pre-set distance.

When the height position difference is greater than or equal to the pre-set height and/or the horizonal distance position difference is greater than or equal to the pre-set distance, the relative position between the infrared photographing device and the visible light photographing device is not aligned. The photographing apparatus is triggered to adjust the position of the infrared photographing device or the position of the visible light photographing device, and executes the processes S21 and S22 iteratively until the position difference is smaller than the pre-set position difference. When the position difference is smaller than the pre-set position difference, it is determined that the infrared photographing device and the visible light photographing device are aligned with each other.

At S202, a transparency parameter is obtained.

In some embodiments, to reduce the amount of the information of the first band image included in the target image, the photographing apparatus receives the transparency parameter inputted by the user through the user interface or receives the transparency parameter sent from the smart terminal to perform a transparency processing on the first band image.

In some embodiments, the photographing apparatus further includes a transparency configuration interface. S102 includes determining the transparency parameter through the transparency configuration interface.

The photographing apparatus includes the transparency configuration interface. The transparency configuration interface may refer to a communication interface. The photographing apparatus uses the communication interface to receive the transparency parameter sent from the smart terminal. The transparency configuration interface may refer to a button or a menu option of the photographing apparatus. The photographing apparatus detects a press operation by the user on the button or a click or slide operation by the user on the menu option to obtain the transparency parameter.

In some embodiments, the photographing apparatus may use different transparency values for processing in different image sections. For example, the transparency configuration interface includes at least one transparency processing frame and a transparency value adjustment option (e.g., a sliding bar). The user can adjust the size and position of each transparency processing frame (the position refers to the position of the transparency processing frame in the first band image), and can set the transparency value for each transparency processing frame through the transparency value adjustment option. The transparency processing frame and the transparency value corresponding to the transparency processing frame together are considered as the transparency parameter. Based on the transparency value corresponding to the transparency processing frame, the transparency processing is performed on the image section of the first band image selected by the transparency processing frame to obtain the first intermediate image. Different transparency processing frames may be configured with different transparency values.

In some embodiments, the photographing apparatus determines the transparency value based on the color spectrum of the first band image. For example, the photographing apparatus divides the first band image into a plurality of image sections, and obtains a parameter range of the color spectrum in each of the plurality of image sections (the color spectrum includes brightness or contrast of the image). Based on the parameter range of the color spectrum in each of the plurality of image sections, a transparency value is configured for the image section. The transparency value in each of the plurality of image sections is used to perform the transparency processing in the corresponding image section to obtain the first intermediate image.

For example, when the parameter of the color spectrum in a first image section falls in a first range, the parameter of the color spectrum in a second image section falls in a second range, and the minimum value in the first range is greater than the maximum value in the second range, it indicates that the first image section provides more information. To equalize the information in each of the plurality of image sections of the first band image, a relatively large transparency value is set for the first image section and a relatively small transparency value is set for the second image section.

In some embodiments, the photographing apparatus determines a foreground image section and a background image section of the first band image based on prior knowledge of the photographed object and/or prior knowledge of the photographed background scene. The foreground image section refers to a section where the photographed object is located. The transparency processing is performed on the foreground image section by using the transparency value set for the foreground image section, and the transparency processing is performed on the background image section by using the transparency value set for the background image section. Thus, the first intermediate image is obtained. For example, to emphasize the foreground image section and de-emphasize the background image section, the photographing apparatus sets a relatively small transparency value for the foreground image section and a relatively large transparency value for the background image section.

At S203, the transparency parameter is used to perform the transparency processing on the first band image to obtain the first intermediate image.

To emphasize the information of the second band image in the target image and use the information of the first band image as the auxiliary information in the target image, the photographing apparatus uses the transparency parameter to perform the transparency processing on the first band image to obtain the first intermediate image. For example, the first band image is the infrared image and the second band image is the visible light image. To emphasize the information of the visible light image to obtain a high resolution target image, the photographing apparatus uses the transparency parameter to perform the transparency processing on the infrared image to obtain the first intermediate image.

In some embodiments, based on the feature information of the first intermediate image and the feature information of the second band image, the first intermediate image and second band image are aligned with each other.

To improve the quality of the target image, the photographing apparatus aligns the first intermediate image and the second band image based on the feature information of the first intermediate image and the feature information of the second band image. Thus, the images photographed by the photographing devices are precisely aligned.

In some embodiments, the feature information of the first intermediate image and the feature information of the second band image are obtained. A first offset between the feature information of the first intermediate image and the feature information of the second band image is determined. Based on the first offset, the first intermediate image is adjusted to obtain the adjusted intermediate image.

The photographing apparatus obtains the feature information of the first intermediate image and the feature information of the second band image, compares between the feature information of the first intermediate image and the feature information of the second band image, and determines the first offset between the feature information of the first intermediate image and the feature information of the second band image. The first offset refers to a position offset of a feature point. Based on the first offset, the first intermediate image is adjusted to obtain the adjusted first intermediate image. In one example, based on the first offset, the first intermediate image is stretched in a horizontal direction or in a vertical direction. In another example, the first intermediate image is compressed in the horizontal direction or in the vertical direction. Thus, the adjusted first intermediate image and the second band image are aligned with each other. Further, the adjusted first intermediate image and the second band image are superimposed to obtain the target image.

In some embodiments, the feature information of the first intermediate image and the feature information of the second band image are obtained. A second offset of the feature information of the second band image relative to the feature information of the first intermediate image is determined. Based on the second offset, the second band image is adjusted to obtain a second intermediate image.

The photographing apparatus obtains the feature information of the first intermediate image and the feature information of the second band image. The feature information of the first intermediate image and the feature information of the second band image are compared to determine the second offset of the feature information of the second band image relative to the feature information of the first intermediate image. The second offset refers a position offset of a feature point. Based on the second offset, the second band image is adjusted o obtain the adjusted second intermediate image. In one example, based on the second offset, the second band image is stretched in the horizontal direction or in the vertical direction. In another example, the second band image is compressed in the horizontal direction or in the vertical direction. Thus, the adjusted second intermediate image is obtained, and the adjusted first intermediate image and the adjusted second intermediate image are aligned with each other. Further, the adjusted first intermediate image and the adjusted second intermediate image are superimposed to obtain the target image.

In some embodiments, the method further includes: performing an alignment processing on a first preview image photographed by the infrared photographing device and a second preview image photographed by the visible light photographing device. For example, the alignment processing is performed on the first preview image photographed by the infrared photographing device and the second preview image photographed by the visible light photographing device to preliminarily align the images photographed by the photographing devices. Thus, redundant information and substantial computing activities can be avoided in combining the images at a pixel level.

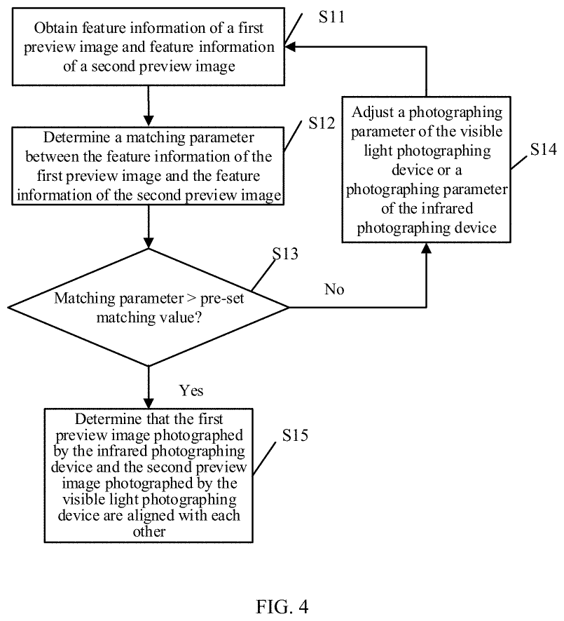

Performing the alignment processing on the first preview image photographed by the infrared photographing device and the second preview image photographed by the visible light photographing device may include the following processes S11-S15 as shown in FIG. 4.

At S11, the feature information of the first preview image and the feature information of the second preview image are obtained.

At S12, a matching parameter between the feature information of the first preview image and the feature information of the second preview image is determined.

At S13, whether the matching parameter is greater than a pre-set matching value is determined. If the matching parameter is smaller than or equal to the pre-set matching value, S14 is executed. Otherwise, S15 is executed.

At S14, a photographing parameter of the visible light photographing device or the photographing parameter of the infrared photographing device is adjusted.

At S15, the first preview image photographed by the infrared photographing device and the second preview image photographed by the visible light photographing image are determined to be aligned with each other.

In the above-described processes S11-S15, the photographing apparatus obtains the feature information of the first preview image and the feature information of the second preview image through a feature extraction algorithm. The feature extraction algorithm includes an algorithm of histogram of oriented gradient (HOG), an algorithm of local binary pattern (LBP), or a Haar integral graph algorithm, etc.

In some embodiments, the feature information at each position of the first preview image is matched with the feature information at corresponding position of the second preview image to obtain the matching parameter. In some embodiments, the feature information of the first preview image and the feature information of the second preview image are sampled according to a pre-set sampling frequency, and the feature information of each sample of the first preview image is matched with the feature information of corresponding sample of the second preview image to obtain the matching parameter. Whether the matching parameter is greater than the pre-set matching value is determined. If the matching parameter is smaller than or equal to the pre-set matching value, it indicates that the difference between the first preview image and the second preview image is relatively large. The photographing apparatus adjusts the photographing parameter of the visible light photographing device or the photographing parameter of the infrared photographing device. The photographing parameter includes parameters such as focal length or aperture, etc. S11-S13 are executed iteratively until the matching parameter is greater than the pre-set matching value. If the matching parameter is greater than the pre-set matching value, it indicates that a similarity between the first preview image and the second preview image is relatively large. That is, the images photographed by the infrared photographing device and the visible light photographing device are the same or the similarity therebetween is relatively large. Hence, it is determined that the first preview image photographed by the infrared photographing device and the second preview image photographed by the visible light photographing device are aligned with each other.

The alignment processing can include various manners. In some embodiments, before the transparency processing is performed on the first band image, the alignment processing is performed on the first band image and the second band image based on the feature information of the first band image and the feature information of the second band image. In some embodiments, after the transparency processing is performed on the first band image, the alignment processing is performed on the first intermediate image and the second band image based on the feature information of the first intermediate image and the feature information of the second band image. In some embodiments, before the first band image and the second band image are obtained, the alignment processing is performed on the first preview image photographed by the infrared photographing device and the second preview image photographed by the visible light photographing device, and before the transparency processing is performed on the first band image, the alignment processing is performed on the first band image and the second band image based on the feature information of the first band image and the feature information of the second band image. In some embodiments, before the first band image and the second band image are obtained, the alignment processing is performed on the first preview image photographed by the infrared photographing device and the second preview image photographed by the visible light photographing device, and after the transparency processing is performed on the first band image, the alignment processing is performed on the first intermediate image and the second band image based on the feature information of the first intermediate image and the feature information of the second band image. The photographing apparatus can select the manner of the image alignment processing according to the photographed scene or according to the user's requirement.

At S204, the first intermediate image and the second band image are superimposed to obtain the target image.

In some embodiments, to obtain more information from the target image, the photographing apparatus superimposes the first intermediate image and the second band image to obtain the target image. For example, the first band image is the infrared image and the second band image is the visible light image. The infrared image includes the temperature information of the photographed object. The visible light image has the high resolution and includes the detailed feature information of the photographed object. Thus, the target image obtained by superimposing the infrared image and the visible light image has a relatively high resolution. The target image includes the temperature information and the detailed feature information of the photographed object. The detailed feature information of the photographed object dominates the target image, thereby facilitating analysis of the detailed features of the photographed object.

In some embodiments, S204 includes: obtaining the infrared feature information from the first intermediate image; obtaining the spectrum feature information from the second band image; and combining the infrared feature information and the spectrum feature information to obtain the target image.

To avoid the redundant information in the target image, the photographing apparatus obtains the infrared feature information from the first intermediate image. The infrared feature information includes the temperature information of the photographed object. The photographing apparatus obtains the visible spectrum feature information from the second band image. The visible spectrum feature information includes the detailed feature information of the photographed object. The infrared feature information and the visible spectrum feature information are combined to obtain the target image. Thus, the target image not only includes the temperature information of the photographed object, but also includes the detailed feature information of the photographed object, thereby improving the quality of the photographed image.

In some embodiments, a compression processing is performed on the first band image and the second band image to obtain compressed data. The compressed data includes a first compressed section for the first band image, a second compressed section for the second band image, and the transparency parameter for performing the transparency processing on the first band image.

The photographing apparatus may store the photographed images. In some embodiments, the photographing apparatus may transmit the photographed images to other devices, for example, when the photographing apparatus mounted at the UAV needs to transmit the photographed images to the smart terminal. To reduce the storage pressure on the photographing apparatus or to reduce the transmission pressure on the transmission link, the photographing apparatus performs the compression processing on the first band image and the second band image through a compression algorithm to obtain the compressed data. The size of the compressed data is way smaller than the size of the target image. That is, the photographing apparatus may reduce the storage space for storing the images or save the transmission bandwidth for transmitting the images. The compression algorithm includes an algorithm of moving picture experts group (MPEG) or an algorithm of joint photographic experts group (JPEG).

The compressed data also includes an indication label for indicating that the compressed data is compressed data of two images. The indication label may include text, a symbol, or a graphic.

In some embodiments, an instruction for decompressing the compressed data is received. Based on the indication label, the first compressed section and the second compressed section of the compressed data are determined. The first band image is obtained by decompressing the first compressed section and the second band image is obtained by decompressing the second compressed section. The transparency parameter included in the compressed data is used to perform the transparency processing on the first band image to obtain the first intermediate image. The first intermediate image and the second band image are superimposed to obtain the target image.

To reconstruct the target image, the photographing apparatus obtains the target image from the compressed data. For example, the user sends the instruction for decompressing the compressed data to the photographing apparatus through the voice command or the touch-control operation. The photographing apparatus receives the decompression instruction and uses the compression algorithm to decompress the compressed data to obtain the first compressed section, the second compressed section, the indication label, and the transparency parameter. The indication label is used to determine the first compressed section and the second compressed section. The first band image is obtained by decompressing the first compressed section and the second band image is obtained by decompressing the second compressed section. The transparency parameter is used to perform the transparency processing on the first band image to obtain the first intermediate image. The first intermediate image and the second band image are superimposed to 0btain the target image. The decompression algorithm includes an MPEG decompression algorithm or a JPEG decompression algorithm.

In some embodiments, the infrared photographing device is the infrared camera and the visible light photographing device is the visible light camera. The first band image photographed by the infrared photographing device is the infrared image. The second band image photographed by the visible light photographing device is the visible light image. The transparency processing is performed on the infrared image to obtain the first intermediate image. The first intermediate image and the visible light image are superimposed to obtain the target image.

The infrared image includes the temperature information of the photographed object. The visible light image has the high resolution and includes the detailed feature information of the photographed object. Thus, the target image includes the temperature information and the detailed feature information of the photographed object. In addition, because the transparency processing is not performed on the visible light image, the target image has the relatively high resolution. The detailed feature information of the photographed object dominates the target image, thereby facilitating analysis of the detailed features of the photographed object, improving the quality of the photographed image, and satisfying the user's requirement for the image quality.

In addition, when it is detected that the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold, the infrared photographing device and the visible light photographing device are structurally aligned with each other and a software program for the alignment is not needed. The above-described alignment method is more reliable and results in more desired photographed images.

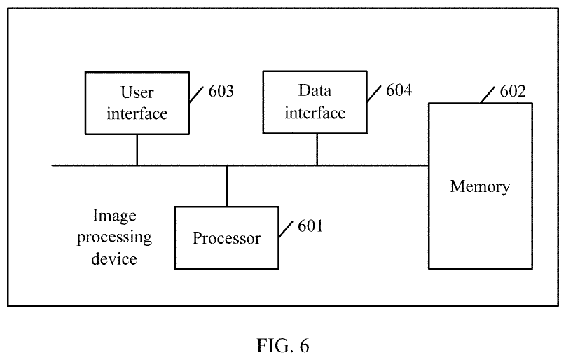

FIG. 6 is a schematic structural diagram of an image processing device according to an example embodiment of the present disclosure. As shown in FIG. 6, the image processing device includes a processor 601, a memory 602, a user interface 603, and a data interface 604. The data interface 604 is configured to send information to other devices, such as sending images to a smart terminal. The user interface 603 is configured to receive a photographing instruction inputted by a user.

The memory 602 can include one or more of a volatile memory and a non-volatile memory. The processor 601 can include one or more of a central processing unit (CPU) and a hardware chip. The hardware chip can include one or more of an application specific integrated circuit (ASIC) and a programmable logic device (PLD). The PLD can include one or more of a complex programmable logic device (CPLD) and a field programmable gate array (FPGA).

In some embodiments, the device also includes a gimbal and a photographing apparatus. The photographing apparatus is mounted at the gimbal. The gimbal is configured with a handle. The handle is configured to control rotation of the gimbal to control the photographing apparatus to photograph images.

In some embodiments, the memory 602 is configured to store program instructions. The processor 601 invokes the program instructions stored in the memory 602 to: obtain a first band image and a second band image; perform a transparency processing on the first band image to obtain a first intermediate image; and superimpose the first intermediate image and the second band image to obtain a target image.

The first band image is an infrared image and the second band image is a visible light image. The infrared image is photographed by an infrared photographing device of the photographing apparatus. The visible light image is photographed by a visible light photographing device of the photographing apparatus. A central horizontal distribution condition is satisfied between the infrared photographing device and the visible light photographing device of the photographing apparatus and/or a relative position between the infrared photographing device and the visible light photographing device of the photographing apparatus is smaller than or equal to a tolerance threshold.

In some embodiments, the processor 601 further invokes the program instructions stored in the memory 602 to: obtain a transparency parameter; and based on the transparency parameter, perform the transparency processing on the first band image to obtain the first intermediate image.

In some embodiments, the processor 601 further invokes the program instructions stored in the memory 602 to determine the transparency parameter through a transparency configuration interface.

In some embodiments, the processor 601 further invokes the program instructions stored in the memory 602 to: perform a compressing processing on the first band image and the second band image to obtain compressed data. The compressed data includes a first compressed section for the first band image, a second compressed section for the second band image, and the transparency parameter for performing the transparency processing on the first band image. The compressed data also includes an indication label for indicating that the compressed data are compressed data of two images.

In some embodiments, the processor 601 further invokes the program instructions stored in the memory 602 to: receive an instruction for decompressing the compressed data; and based on the indication label; determine the first compressed section and the second compressed section in the compressed data; decompress the first compressed section to obtain the first band image and decompress the second compressed section to obtain the second band image; use the transparency parameter to perform the transparency processing on the first band image to obtain the first intermediate image; and superimpose the first intermediate image and the second band image to obtain the target image.

In some embodiments, the processor 601 further invokes the program instructions stored in the memory 602 to: obtain infrared feature information from the first intermediate image; obtain visible light feature information from the second band image; and combine the infrared feature information and the visible light feature information to obtain the target image.

In some embodiments, the processor 601 further invokes the program instructions stored in the memory 602 to: perform an alignment processing on a first preview image photographed by the infrared photographing device and a second preview image photographed by the visible light photographing device.

In some embodiments, the processor 601 further invokes the program instructions stored in the memory 602 to: obtain the feature information of the first preview image and the feature information of the second preview image; determine a matching parameter between the feature information of the first preview image and the feature information of the second preview image; and if the matching parameter is smaller than or equal to a pre-set matching value, adjust a photographing parameter of the visible light photographing device or the photographing parameter of the infrared photographing device.

In some embodiments, the processor 601 further invokes the program instructions stored in the memory 602 to: based on the feature information of the first intermediate image and the feature information of the second band image, perform the alignment processing on the first intermediate image and the second band image.

In some embodiments, the processor 601 further invokes the program instructions stored in the memory 602 to: obtain the feature information of the first intermediate image and the feature information of the second band image; determine a first offset of the feature information of the first intermediate image relative to the feature information of the second band image; based on the first offset, adjust the first intermediate image to obtain the adjusted first intermediate image; and superimpose the adjusted first intermediate image and the second band image to obtain the target image.

In some embodiments, the processor 601 further invokes the program instructions stored in the memory 602 to: obtain the feature information of the first intermediate image and the feature information of the second band image; determine a second offset of the feature information of the second band image relative to the feature information of the first intermediate image; based on the second offset, adjust the second band image to obtain the second intermediate image; and superimpose the first intermediate image and the second intermediate image to obtain the target image.

In some embodiments, the processor 601 further invokes the program instructions stored in the memory 602 to: based on position information of the infrared photographing device and the position information of the visible light photographing device, perform alignment on a relative position between the infrared photographing device and the visible light photographing device.

In some embodiments, the processor 601 further invokes the program instructions stored in the memory 602 to: based on lens position of the infrared photographing device relative to the photographing apparatus and the lens position of the visible light photographing device relative to the photographing apparatus, calculate a position difference between the infrared photographing device and the visible light photographing device; and if the position difference is greater than or equal to a pre-set position difference, adjust position of the infrared photographing device or the position of the visible light photographing device.

In some embodiments, the transparency processing is performed on the first band image to obtain the first intermediate image. The first intermediate image and the second band image are superimposed to obtain the target image. The target image includes the information of the first band image and the information of the second band image. More amount of the information can be obtained from the target image to improve the quality of the photographed image. In addition, through performing the transparency processing on the first band image, the target image can highlight the information of the second band image and use the information of the first band image as auxiliary information, such that a target image including primary and secondary information can be obtained.

In addition, when it is detected that the central horizontal distribution condition is satisfied between the infrared photographing device and the visible light photographing device of the photographing apparatus and/or the relative position between the infrared photographing device and the visible light photographing device of the photographing apparatus is smaller than or equal to the tolerance threshold, the infrared photographing device and the visible light photographing device are structurally aligned with each other and a software program for the alignment is not needed. The above-described alignment method is more reliable and results in more desired photographed images.

The present disclosure also provides a UAV. The UAV includes a body, a power system arranged at the body to provide flying power, a photographing apparatus mounted at the body, and a processor. The processor is configured to control an infrared photographing device of the photographing apparatus mounted at the UAV to photograph a first band image and to control a visible light photographing device of the photographing apparatus mounted at the UAV to photograph a second band image. The processor is further configured to perform a transparency processing on the first band image to obtain a first intermediate image. The processor is further configured to superimpose the first intermediate image and the second band image to obtain a target image. A central horizontal distribution condition is satisfied between the infrared photographing device and the visible light photographing device of the photographing apparatus and/or a relative position between the infrared photographing device and the visible light photographing device of the photographing apparatus is smaller than or equal to a tolerance threshold.

The present disclosure also provides a computer-readable storage medium. The computer-readable storage medium stores computer programs. The computer programs are executed by a processor to implement, e.g., the image processing method as shown in FIG. 2 or FIG. 3 or the image processing device as shown in FIG. 6 consistent with the embodiments of the present disclosure, and detail description is omitted.

The computer-readable storage medium may include an internal storage unit, e.g., a hard disk or a memory, of the image processing device consistent with the embodiments of the present disclosure. The computer-readable storage medium may include an external storage device of the image processing device, such as a plug-in hard drive of the image processing device, a smart media card (SMC), a secure digital (SD) card, a flash card, etc. Further, the computer-readable storage medium may include both the internal storage unit of the image processing device and the external storage device of the image processing device. The computer-readable storage medium stores the computer programs and other programs and data required by the device. The computer-readable storage medium may also temporarily store data that have been outputted and will be outputted.

Those of ordinary skill in the art may understand that all or part of the processes of implementing the foregoing method embodiments may be completed by a program instructing related hardware. The program may be stored in the computer-readable storage medium. When being executed, the program implements the method embodiments. The computer-readable storage medium includes, but is not limited to, various media for storing the program codes, such as a read-only memory (ROM), a random-access memory (RAM), a magnetic disk, and an optical disk.

Various embodiments of the present disclosure are used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. The scope of invention should be determined by the appended claims.

What is claimed is:

1. An image processing method comprising:
obtaining a first band image and a second band image;
performing transparency processing on the first band image to obtain an intermediate image; and
superimposing the intermediate image and the second band image to obtain a target image.

2. The method of claim 1, wherein:
the first band image is an infrared image photographed by an infrared photographing device of a photographing apparatus;
the second band image is a visible light image photographed by a visible light photographing device of the photographing apparatus; and
positions of the infrared photographing device and the visible light photographing device satisfy at least one of:
a central horizontal distribution condition; or
a condition that a relative position between the infrared photographing device and the visible light photographing device of the photographing apparatus is smaller than or equal to a tolerance threshold.

3. The method of claim 1, wherein performing the transparency processing on the first band image to obtain the intermediate image includes:
obtaining a transparency parameter; and
performing the transparency processing on the first band image based on the transparency parameter to obtain the intermediate image.

4. The method of claim 3, wherein obtaining the transparency parameter includes determining the transparency parameter through a transparency configuration interface of a photographing apparatus capturing the first band image and the second band image.

5. The method of claim 1, further comprising:
performing compression processing on the first band image and the second band image to obtain compressed data, the compressed data including a first compressed section for the first band image, a second compressed section for the second band image, and a transparency parameter for performing the transparency processing on the first band image.

6. The method of claim 5, wherein the compressed data further includes an indication label for indicating that the compressed data is compressed data of two images.

7. The method of claim 6, further comprising:
receiving an instruction for decompressing the compressed data;
determining the first compressed section and the second compressed section in the compressed data based on the indication label; and
decompressing the first compressed section to obtain the first band image and decompressing the second compressed section to obtain the second band image;
wherein the transparency processing is performed on the first band image based on the transparency parameter included in the compressed data.

8. The method of claim 1, wherein superimposing the intermediate image and the second band image to obtain the target image includes:
obtaining infrared feature information from the intermediate image;
obtaining visible spectrum feature information from the second band image; and
combining the infrared feature information and the visible spectrum feature information to obtain the target image.

9. The method of claim 1, further comprising, after performing the transparency processing on the first band image:
performing alignment processing on the intermediate image and the second band image based on feature information of the intermediate image and feature information of the second band image.

10. The method of claim 9, wherein:
performing the alignment processing on the intermediate image and the second band image based on the feature information of the intermediate image and the feature information of the second band image includes:
obtaining the feature information of the intermediate image and the feature information of the second band image;
determining an offset of the feature information of the intermediate image relative to the feature information of the second band image; and
adjusting the intermediate image based on the offset to obtain an adjusted intermediate image; and
superimposing the intermediate image and the second band image to obtain the target image includes superimposing the adjusted intermediate image and the second band image to obtain the target image.

11. The method of claim 9, wherein:
the intermediate image is a first intermediate image;
performing the alignment processing on the intermediate image and the second band image based on the feature information of the intermediate image and the feature information of the second band image includes:
obtaining the feature information of the first intermediate image and the feature information of the second band image;
determining an offset of the feature information of the second band image relative to the feature information of the first intermediate image; and
adjusting the second band image based on the offset to obtain a second intermediate image; and
superimposing the intermediate image and the second band image to obtain the target image includes superimposing the first intermediate image and the second intermediate image to obtain the target image.

12. The method of claim 9, further comprising:
performing the alignment processing on a first preview image photographed by an infrared photographing device of a photographing apparatus and a second preview image photographed by a visible light photographing device of the photographing apparatus.

13. The method of claim 12, wherein performing the alignment processing on the first preview image photographed by the infrared photographing device and the second preview image photographed by the visible light photographing device includes:
obtaining feature information of the first preview image and feature information of the second preview image;
determining a matching parameter between the feature information of the first preview image and the feature information of the second preview image; and
in response to the matching parameter being smaller than or equal to a pre-set matching value, adjusting a photographing parameter of the visible light photographing device or a photographing parameter of the infrared photographing device.

14. The method of claim 1, further comprising, before obtaining the first band image and the second band image:
performing alignment on a relative position between an infrared photographing device of a photographing apparatus that captures the first band image and a visible light photographing device of the photographing apparatus that captures the second band image based on position information of the infrared photographing device and position information of the visible light photographing device.

15. The method of claim 14, wherein performing alignment on the relative position between the infrared photographing device and the visible light photographing device based on the position information of the infrared photographing device and the position information of the visible light photographing device includes:
calculating a position difference between the infrared photographing device and the visible light photographing device based on a position of the infrared photographing device relative to the photographing apparatus and a position of the visible light photographing device relative to the photographing apparatus; and
in response to the position difference being greater than or equal to a pre-set position difference, adjusting the position of the infrared photographing device or the position of the visible light photographing device.

16. An image processing device comprising:
a memory storing program instructions; and
a processor configured to execute the program instructions to:
obtain a first band image and a second band image;
perform transparency processing on the first band image to obtain an intermediate image; and
superimpose the intermediate image and the second band image to obtain a target image.

17. The device of claim 16, wherein:
the first band image is an infrared image photographed by an infrared photographing device of a photographing apparatus;
the second band image is a visible light image photographed by a visible light photographing device of the photographing apparatus; and
positions of the infrared photographing device and the visible light photographing device satisfy at least one of:
a central horizontal distribution condition; or
a condition that a relative position between the infrared photographing device and the visible light photographing device of the photographing apparatus is smaller than or equal to a tolerance threshold.

18. The device of claim 16, wherein the processor is further configured to execute the program instructions to:
obtain a transparency parameter; and
perform the transparency processing on the first band image based on the transparency parameter to obtain the intermediate image.

19. The device of claim 16, wherein the processor is further configured to execute the program instructions to:
obtain infrared feature information from the intermediate image;
obtain visible spectrum feature information from the second band image; and
combine the infrared feature information and the visible spectrum feature information to obtain the target image.

20. An unmanned aerial vehicle (UAV) comprising:
a body;
a power system arranged at the body and configured to provide flying power;
a photographing apparatus mounted at the body; and
a processor configured to:
obtain a first band image and a second band image;
perform transparency processing on the first band image to obtain an intermediate image; and
superimpose the intermediate image and the second band image to obtain a target image.
